(19) United States
(12) Patent Application Publication
(10) Pub. No.: US 2024/0195137 A1
(43) Pub. Date: Jun. 13, 2024

(54) SELF-SIMILAR REGENERATIVE AMPLIFICATION METHOD AND APPARATUS FOR FEMTOSECOND LASER CHIRPED PULSES

(71) Applicants: Chongqing Huapu Information Technology Co.,Ltd., Chongqing (CN); Chongqing Huapu Scientific Instrument Co.,Ltd., Chongqing (CN); Chongqing Huapu Intelligent Equipment Co., Ltd., Chongqing (CN); Yunnan Huapu quantum Material Co., Ltd, Kunming, Yunnan (CN); ROI Optoelectronics Technology CO, LTD., Shanghai (CN); GuangDong ROI Optoelectronics Technology Co., Ltd., Dongguan, Guangdong (CN); Chongqing Institute of East China Normal University, Chongqing (CN); East China Normal University, Shanghai (CN)

(72) Inventors: Heping ZENG, Chongqing (CN); Zhengru GUO, Chongqing (CN); Xiao WANG, Chongqing (CN); Xiaowei QIAN, Chongqing (CN); Tianjun YAO, Chongqing (CN); Tingting LIU, Chongqing (CN); Mengyun HU, Chongqing (CN)

(21) Appl. No.: 18/529,332

(22) Filed: Dec. 5, 2023

(30) Foreign Application Priority Data
Dec. 7, 2022 (CN) 202211566424.5

(51) Int. Cl. H01S 3/00; H01S 3/10; H01S 3/16

(52) U.S. Cl. CPC H01S 3/0057; H01S 3/10084; H01S 3/1618

(57) ABSTRACT

The present disclosure provides a self-similar regenerative amplification method and an apparatus. The apparatus includes a broadband seed source, a spectrum shaping broader, a self-similar regenerative amplifier and a pulse compressor disposed in order of a light path. The spectrum shaping broader includes a time domain broader and a spectrum shaper. The time domain broader is configured to broaden the seed pulses, and fine-tune a width of the seed pulse. The spectrum shaper is configured to perform spectrum shaping on the broadened pulses to obtain saddle chirped pulses. The pulse regenerative amplification component includes a gain crystal and a nonlinear crystal. The self-similar regenerative amplifier receives the saddle chirped pulses, performs multiple stepwise amplifications and multiple nonlinear spectrum broadenings back and forth on the saddle chirped pulses, and output high-energy chirped pulses to the pulse compressor.

### CROSS-REFERENCE TO RELATED APPLICATION

This application claims priority to Chinese Patent Application No. 202211566424.5, filed Dec. 7, 2022, the entire disclosure of which is incorporated herein by reference.

### TECHNICAL FIELD

The disclosure relates to a field of ultrafast laser technology, in particular to a self-similar regenerative amplification method for femtosecond laser chirped pulses and a self-similar regenerative amplification apparatus for femtosecond laser chirped pulses.

### BACKGROUND

Solid-state laser amplifiers doped with ytterbium ions have a major advantage in high-energy strong-field pulse generation due to high quantum efficiency and simple pumping requirements. The solid-state lasers doped with ytterbium ions, such as all solid state (crystal gain medium), discs, slats, and fibers, have improved the output energy of the laser amplifier to the millijoule level.

Recently, in combination with the chirped pulse amplification technology, the solid-state laser amplifiers doped with ytterbium ions may output femtosecond pulses at the millijoule level, with a pulse peak power reaching a GW level. In a chirped amplification system, in order to avoid the adverse effects caused by the high peak power pulses, such as self-focusing and device damage, it is generally needed to broaden the seed pulses to a hundred-picosecond level, but the pulse broadening leads to a reduction in nonlinearity in the amplification process, and the adverse effect of gain narrowing becomes obvious, resulting in a limited pulse output width, generally above 300 fs. The gain narrowing is caused by the inconsistency of the radiation spectrum distribution of the laser gain medium. For example, the gain medium doped with Yb ions has a radiation spectrum covering a wide range of 1010 to 1100 nm, but the radiation intensity is generally maximum at 1035 nm and becomes weaker on both sides. Therefore, in the laser amplification process based on the materials doped with Yb ions, the pulse spectrum in 1035 nm band becomes prominent as the increase in the amplification because of the easy amplification at 1035 nm, resulting in the concentration of the amplified pulse spectrum around 1035 nm, which causes spectral narrowing. According to the Fourier transform limit pulse theory, in order to obtain narrower output pulses, the pulses need to have a wider spectral bandwidth. Therefore, the suppression of the gain narrowing effect during laser amplification and even realization of spectral broadening may advance the output pulse width of ytterbium-doped solid-state laser amplifiers to the 100 fs level or even to the 10 fs level.

The self-similar pulse amplification was first realized in the fiber laser amplifier, which is capable of obtaining ultrashort pulses of sub-hundred picosecond or even at a short cycle by exploiting the nonlinear effects in the fiber gain medium to broaden the signal optical spectrum, thereby suppressing gain narrowing and achieving high-quality pulse compression. Current self-similar amplification is only used in fiber amplifiers, where the long action distance and high nonlinearity characteristics of the fiber medium guarantee that self-similar pulse evolution is achieved. However, the output energy is limited to the μJ level due to the low damage threshold and drastic nonlinearity of the fiber medium. Based on the chirped amplification system and the solid-state regenerative amplification system, it is hard to achieve self-similar pulse evolution due to low peak pulse power and low gain crystal nonlinearity coefficient (3-4 orders of magnitude lower than that of the fiber medium).

### SUMMARY

A self-similar regenerative amplification method for femtosecond laser chirped pulses is provided. The method includes: continuously injecting seed pulses into a spectrum shaping broader, performing time domain broadening on the injected seed pulses by a time domain broader, and performing spectrum shaping on the pulses broadened to a hundred-picosecond level or even a nanosecond level by a spectrum shaper during or after the time domain broadening process, to obtain saddle chirped pulses with a spectrum intensity descending from both edges to a center, in which the seed pulses have a spectral width >7 nm, a pulse energy >1 nJ, a parabolic or Gaussian spectral shape, and a linear chirped characteristic: injecting the saddle chirped pulses after the time domain broadening and spectrum shaping into a regenerative amplification chamber of a self-similar regenerative amplifier, and obtaining gains in spectrums of the saddle chirped pulses after multiple stepwise amplifications back and forth in the regenerative amplification chamber by a gain crystal and a highly nonlinear crystal: after spectrum intensities of the saddle chirped pulses evolve from saddle to flat shape, continuing to perform multiple stepwise amplifications back and forth on flat chirped pulses in the regenerative amplification chamber using the gain crystal, so that when a pulse peak power exceeds a MW level, nonlinear spectrum broadening is accomplished on the flat chirped pulses by the highly nonlinear crystal: in the process of regenerative amplification, after the chirped pulses pass through a gain medium as a focused light spot and then pass through a highly nonlinear medium as the focused light spot after being collimated by a lens, enhancing the nonlinear spectrum broadening until the chirped pulses reach gain saturation after self-similar amplification, and outputting high-energy chirped pulses; and injecting the high-energy chirped pulses after gain saturation into a pulse compressor, and outputting compressed pulses after pulse compression of the high-energy chirped pulses by the pulse compressor, in which, at this point, the pulses have a pulse energy larger then 2 mJ, a pulse width less than 100 fs, a spectral width larger than 15 nm, and a switchable repetition frequency range of 1 kHz to 200 KHz.

Furthermore, performing the time domain broadening on the seed pulses and performing spectrum shaping on the broadened pulses include: performing multiple time domain broadenings on the seed pulses by the time domain broader, and performing the spectrum shaping on the broadened pulses during the time domain broadening by the spectrum shaper; or performing the time domain broadening once on the seed pulses by the time domain broader, and performing the spectrum shaping on the broadened pulses by the spectrum shaper after the time domain broadening.

Furthermore, the gain crystal in the self-similar regenerative amplifier is a laser crystal doped with rare earth ions, and the laser crystal emits a spontaneous radiation laser after being activated by pump light.

Furthermore, the rare earth ions doped in the laser crystal are neodymium ions or ytterbium ions, and the spontaneous radiation laser is Yb:CaF2 spontaneous radiation laser, Yb:CALGO spontaneous radiation laser, Yb:CALYO spontaneous radiation laser, or Yb:KGW/KYW spontaneous radiation laser.

Furthermore, the highly nonlinear crystal refers to a crystal material having a high third-order nonlinear optical polarization rate, including silicon dioxide, calcium fluoride, or aluminum oxide.

A self-similar regenerative amplification apparatus for femtosecond laser chirped pulses is provided. The apparatus includes:
a broadband seed source configured to emit seed pulses:
a spectrum shaping broader configured to receive the seed pulses from the broadband seed source and including:
a time domain broader configured to broaden the seed pulses to a hundred-picosecond level or even a nanosecond level, and fine-tune a pulse width of the seed pulses;
a spectrum shaper configured to perform spectrum shaping on the broadened pulses to obtain saddle chirped pulses with a spectrum intensity descending from both edges to a center;
a pulse input and output coupling component configured to receive the saddle chirped pulses injected by the spectrum shaping broader and output the received saddle chirped pulses;
a pulse regenerative amplification component configured to receive the saddle chirped pulses output from the pulse input and output coupling component and perform multiple stepwise amplifications back and forth on the saddle chirped pulses, the pulse regenerative amplification component including:
a gain crystal; and
a highly nonlinear crystal is located on a side where the gain crystal is located and in the same optical path as the gain crystal, and configured to perform multiple stepwise amplifications and multiple nonlinear spectrum broadenings back and forth on the saddle chirped pulses together with the gain crystal until a pulse peak power exceeds a MW level; in which after the chirped pulses pass through the gain medium as a focused light spot and then pass through the highly nonlinear medium as the focused light spot after being collimated by a lens, the nonlinear spectrum broadening is enhanced until the chirped pulses reach gain saturation after self-similar amplification, and the pulse regenerative amplification component is further configured to output high-energy chirped pulses to the pulse input and output coupling component: the pulse input and output coupling component is further configured to receive and output the high-energy chirped pulses into the pulse compressor; and
a pulse compressor configured to compress the high-energy chirped pulses and output compressed pulses,
in which the broadband seed source, the spectrum shaping broader, the self-similar regenerative amplifier and the pulse compressor are disposed in order of a light path from one side to the other side.

Furthermore, the time domain broader is an offner grating time domain broader, including a thin film polarizer, a Faraday rotator, a half-wave plate, a diffraction grating, a concave mirror, and a convex mirror that are placed in order of the light path. A ridge retroreflector and a plane reflector are provided between the half-wave plate and the diffraction grating, and the ridge retroreflector is disposed close to the half-wave plate. The concave mirror and the convex mirror are arranged alternatively one above the other, and the ridge retroreflector and the plane reflector are arranged alternatively one above the other. A radius of curvature of the convex mirror is half of that of the concave mirror. The convex mirror is located at a focus location of the concave mirror. The spectrum shaper is a mechanical spectrum shaper, and located between the concave mirror and the convex mirror, the mechanical spectrum shaper includes one or more opaque mechanical sheets, and a slit exists between two adjacent opaque mechanical sheets.

Furthermore, a working waveband of any of the thin film polarizer, the Faraday rotator, the half-wave plate, the diffraction grating, the concave mirror, the convex mirror, the ridge retroreflector and the plane reflector is 1030 nm. The Faraday rotator is configured to rotate a polarization angle of incident polarized light by 45°, and separate and isolate incident light and emergent light in combination with the half-wave plate and the thin film polarizer, and is used as an optical isolator. A ruling cycle of the diffraction grating is 1740 lines/mm, and a single-pass diffraction efficiency of laser at a waveband of 1030 nm is greater than 95%.

Furthermore, the time domain broader is an optical fiber broader implemented based on a chirped Bragg grating, and the spectrum shaper is an optical interference filter shaper implemented based on a birefringence effect:
the time domain broader includes a fiber annulus, a chirped fiber Bragg grating and a fiber collimator disposed in order of the optical path, a first port, a second port and a third port are arranged on the fiber annulus at intervals, an incident signal light from the first port is unidirectionally transmitted to the second port, and an incident signal light from the second port is unidirectionally transmitted to the third port: the chirped fiber Bragg grating has a reflection bandwidth of 20 nm, a reflection rate greater than 50%, a dispersion coefficient of 50 ps/nm, and an optical fiber type of PM980; and
the spectrum shaper includes a third film polarizer, a birefringence medium and a fourth film polarizer disposed in order of the optical path, the birefringence medium is quartz crystal, a birefringence coefficient B=0.0092, an angle between an incident laser polarization direction and a main axis of the birefringence medium is 15°; and an angle formed between an optical axis of the birefringence medium and a laser transmission polarization axis is 0, in which 0°<θ<90°.

Furthermore, the pulse input and output coupling component includes a first thin film polarizer, a first half-wave plate, a first Faraday rotator disposed in sequence; the first Faraday rotator is disposed close to the pulse regenerative amplification component, the first Faraday rotator is a magneto-optical crystal device, a polarization angle of polarized light rotates by 45° after the polarized light passes through the first Faraday rotator; the first Faraday rotator, the first half-wave plate and the first thin film polarizer constitute an optical isolator, and the optical isolator is configured to perform coupling or isolation on the incident light and the emergent light;
the pulse regenerative amplification component further includes a first plane reflector, a Pockels cell, a quarter-wave plate, a second thin film polarizer and a second plane reflector disposed in sequence: the gain crystal and the highly nonlinear crystal are located between the second plane reflector and the second thin film polarizer; the second thin film polarizer is disposed opposite to the first Faraday rotator, and the second thin film polarizer is configured to receive the saddle chirped pulses from the first Faraday rotator, rotate the saddle chirped pulses by a set angle and direct the saddle chirped pulses into the quarter-wave plate;
a first plano-convex lens and a second plano-convex lens are provided on both sides of the highly nonlinear crystal, respectively, and a third plano-convex lens and a fourth plano-convex lens are provided on both sides of the gain crystal, respectively; the first plano-convex lens, the second plano-convex lens, the third plano-convex lens, the fourth plano-convex lens, the first plane reflector and the second plane reflector together form a stable regenerative chamber: the highly nonlinear crystal is placed at a focus location of a convex lens group formed by the first plano-convex lens and the second plano-convex lens, and the gain crystal is placed at a focus location of a convex lens group formed by the third plano-convex lens and the fourth plano-convex lens; and
the Pockels cell is a quarter-wave fast electro-optical device, and the Pockels cell and the quarter-wave plate together form an optical regulator for adjusting a polarization direction of polarized light by controlling opening and closing of the Pockels cell, so that multiple stepwise amplifications and multiple nonlinear spectrum broadenings are performed on the saddle chirped pulses back and forth between the first plane reflector and the second plane reflector.

### BRIEF DESCRIPTION OF THE DRAWINGS

FIG. 1 is a schematic diagram showing a self-similar regenerative amplification apparatus for femtosecond laser chirped pulses in Example 1 and Example 2.

FIG. 2 is a schematic diagram showing a spectrum shaping broader in Example 1.

FIG. 3 is a schematic diagram showing a spectrum shaping broader in Embodiment 2.

FIG. 4 is a schematic diagram showing a self-similar regenerative amplifier in Example 1 and Example 2.

FIG. 5 is a schematic diagram showing a saddle spectrum output by a spectrum shaping broader after broadening and shaping in an embodiment.

FIG. 6 is a schematic diagram showing amplified vertical simulation results of Gaussian spectrum and saddle spectrum with the same parameters after being input into the self-similar regenerative amplifier in an embodiment, in which (a) is energy evolution of two spectrums and (b) is amplified spectrum width evolution of two spectrums.

FIG. 7 is a schematic diagram showing self-similar regenerative amplification pulse evolution of Gaussian spectrum and saddle spectrum in ane embodiment, in which (a) and (c) are schematic diagrams of evolution of Gaussian incident pulses, and (b) and (d) are schematic diagrams of evolution of saddle incident pulses.

FIG. 8 is a schematic diagram showing amplification evolution of narrow-band signal light pulses in an self-similar regenerative amplification apparatus for femtosecond laser chirped pulses in an embodiment, in which (a) is pulse evolution, (b) is spectrum evolution, (c) is a pulse curve at a specific number of turns, and (d) is a spectrum curve at a specific number of turns.

FIG. 9 is a schematic diagram showing a change process of pulse width and spectrum width of broadband signal light pulses in self-similar regenerative amplification apparatus for femtosecond laser chirped pulses.

### DETAILED DESCRIPTION

In order to make the objects, technical solutions and advantages of the embodiments of the disclosure clearer, the technical solutions in the embodiments of the disclosure will be clearly and completely described below in combination with the accompanying drawings in the embodiments of the disclosure. Obviously, the described embodiments are a part of the embodiments of the disclosure, and not all of them. Generally, the components of the embodiments of the disclosure described and illustrated in the accompanying drawings herein may be arranged and designed in a variety of different configurations. Therefore, the following detailed description of the embodiments of the disclosure provided in the accompanying drawings is not intended to limit the claimed protection scope of the disclosure, but merely to indicate selected embodiments of the disclosure. Based on the embodiments of the disclosure, all other embodiments obtained without inventive works by those skilled in the art fall within the scope of protection of the disclosure.

It should be noted that similar symbols and letters indicate similar items in the accompanying drawings below, so that once an item is defined in one of the accompanying drawings, it need not be further defined and explained in the subsequent drawings. In the description of the disclosure, it should be noted that orientations or location relations indicated by the terms “center”, “top”, “bottom”, “left”, “right”, “vertical”, “horizontal”, “inside”, and “outside” are based on the orientations or location relations shown in the accompanying drawings, or the orientations or location relations in which the products of the disclosure are customarily placed when in use, only for the purpose of facilitating and simplifying the description of the invention, and not to indicate or imply that the devices or components referred to must have a particular orientation, or be constructed and operated in a particular orientation, which are not to be construed as a limitation of the invention. In addition, the terms “first”, “second”, “third”, etc. are used only to distinguish different descriptions and are not to be construed as indicating or implying relative importance. In addition, the terms “horizontal”, “vertical”, etc. do not mean that the part is required to be absolutely horizontal or overhanging, but can be slightly inclined. For example, “horizontal” only means that its direction is more horizontal compared to “vertical”, it does not mean that the structure must be completely horizontal, but can be slightly inclined. In the description of the invention, it should also be noted that, unless otherwise expressly specified and limited, the terms “set”, “installed”, “coupled”, and “connected” should be understood in a broad sense, for example, as a fixed connection, a removable connection, an integral connection, a mechanical connection, an electrical connection, a direct connection, an indirect connection through an intermediate medium, or a connection within two elements. For those skilled in the art, the specific meaning of the above terms in the contexts of the disclosure can be understood in specific cases.

To overcome the above shortcomings in the related art, an object of the disclosure is to provide a self-similar regenerative amplification method for femtosecond laser chirped pulses, and a self-similar regenerative amplification apparatus for femtosecond laser chirped pulses, which solve the problem that self-similar pulse evolution is hard to be realized in the solid-state laser amplifier and the chirped amplification system, break through the limitation of gain narrowing effect in the high-energy femtosecond laser generation, and realize the self-similar pulse evolution of laser pulses in the solid-state regenerative amplifier. The amplification process is accompanied by spectrum broadening, which provides a new technical means for realizing high peak power pulse generation of 10 mJ at a sub-hundred-picosecond level.

A self-similar regenerative amplification method for femtosecond laser chirped pulses is provided. The method includes: continuously injecting seed pulses into a spectrum shaping broader, performing time domain broadening on the injected seed pulses by a time domain broader, and performing spectrum shaping on the pulses broadened to a hundred-picosecond level or even a nanosecond level by a spectrum shaper during or after the time domain broadening process, to obtain saddle chirped pulses with a spectrum intensity descending from both edges to a center, in which the seed pulses have a spectral width >7 nm, a pulse energy >1 nJ, a parabolic or Gaussian spectral shape, and a linear chirped characteristic: injecting the saddle chirped pulses after the time domain broadening and spectrum shaping into a regenerative amplification chamber of a self-similar regenerative amplifier, and obtaining gains in spectrums of the saddle chirped pulses after multiple stepwise amplifications back and forth in the regenerative amplification chamber by a gain crystal and a highly nonlinear crystal; after spectrum intensities of the saddle chirped pulses evolve from saddle to flat shape, continuing to perform multiple stepwise amplifications back and forth on flat chirped pulses in the regenerative amplification chamber using the gain crystal, so that when a pulse peak power exceeds a MW level, nonlinear spectrum broadening is accomplished on the flat chirped pulses by the highly nonlinear crystal; in the process of regenerative amplification, after the chirped pulses pass through a gain medium as a focused light spot and then pass through a highly nonlinear medium as the focused light spot after being collimated by a lens, enhancing the nonlinear spectrum broadening until the chirped pulses reach gain saturation after self-similar amplification, and outputting high-energy chirped pulses; and injecting the high-energy chirped pulses after gain saturation into a pulse compressor, and outputting compressed pulses after pulse compression of the high-energy chirped pulses by the pulse compressor, in which, at this point, the pulses have a pulse energy larger then 2 mJ, a pulse width less than 100 fs, a spectral width larger than 15 nm, and a switchable repetition frequency range of 1 kHz to 200 kHz.

By combining the chirped pulse amplification, the self-similar pulse amplification and the solid-state laser regenerative amplification, the gain narrowing effect in the high-energy ultrafast laser amplification may be resolved with a millijoule-level high peak power pulse output <100 fs.

Self-similar regenerative amplification is achieved by inserting a nonlinear medium inside the solid laser regenerative amplifier, which solves the problem that it is hard to achieve self-similar pulse evolution in a low nonlinear solid gain medium and provides a new manner for suppressing gain narrowing in multi-pass regenerative amplifications.

### Example 1

The self-similar regenerative amplification method for femtosecond laser chirped pulses of the embodiment of the present disclosure includes the following steps. A seed pulse δ1 is (which has a spectral width >7 nm, a pulse energy >1 nJ, a parabolic or Gaussian spectral shape, and a linear chirped characteristic) continuously injected into a spectrum shaping broader 200. Time domain broadening is performed twice on the injected seed pulses δ1 by a time domain broader of the spectrum shaping broader 200, and spectrum shaping is performed on a signal light broadened by a spectrum shaper during or after the time domain broadening process to enable the pulse to a hundred-picosecond level or even a nanosecond level, so as to obtain a saddle chirped pulse δ2 with a spectrum intensity descending from both sides to a center. The saddle chirped pulse δ2 after the time domain broadening and spectrum shaping is injected into a regenerative amplification chamber of a self-similar regenerative amplifier 300. The saddle chirped pulse is subjected to multiple stepwise amplifications back and forth in the regenerative amplification chamber by a gain crystal and a highly nonlinear crystal. Based on an effect of the gain crystal, a middle part of the seed pulse spectrum gradually grows up, and both sides of the seed pulse spectrum weakens. The gain narrowing effect is canceled out the initial saddle shaped spectrum, causing the spectral intensity of the saddle chirped pulse to evolve from a saddle shape to a flat shape to obtain a flat chirped pulse. The flat chirped pulse is subjected multiple stepwise amplifications back and forth in the regenerative amplification chamber using the gain crystal. When a pulse peak power exceeds a MW level, nonlinear spectrum broadening is accomplished on the flat chirped pulses by the highly nonlinear crystal. The signal light is formed as a focused light spot to pass through a gain medium, which avoids nonlinear time-frequency distortion. After being collimated by a lens, the signal light pass through a highly nonlinear medium as the focused light spot, enhancing the nonlinear spectrum broadening. When the chirped pulses reach gain saturation after self-similar amplification, a high-energy chirped pulse δ3 is output. The high-energy chirped pulse δ3 after gain saturation is injected into a pulse compressor 400 to perform pulse compression, so as to output a signal light δ4 after pulse compression. The signal light δ4 has a pulse energy larger than 2 mJ, a pulse width less than 100 fs, a spectral width larger than 15 nm, and a switchable repetition frequency ranging 1 kHz to 200 KHz.

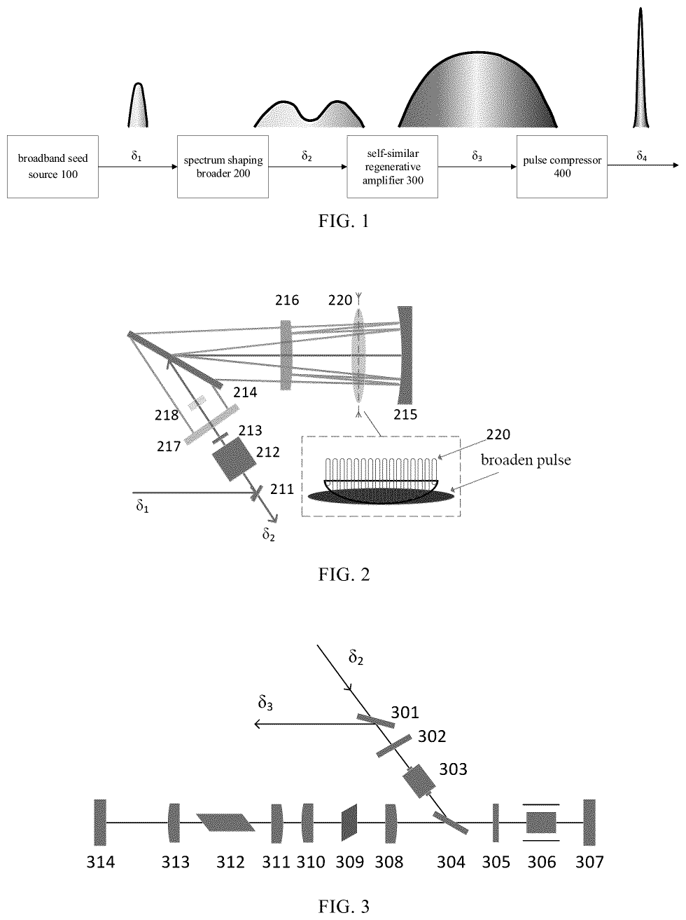

As shown in FIG. 1, a self-similar regenerative amplification apparatus for femtosecond laser chirped pulses is provided, which is used to perform the self-similar regenerative amplification method for femtosecond laser chirped pulses in embodiments of the present disclosure, and includes: a broadband seed source 100, a spectrum shaping broader 200, a self-similar regenerative amplifier 300 and a pulse compressor 400 disposed in an order of a light path from one side to the other side. The broadband seed source 100 is configured to emit seed pulses.

The spectrum shaping broader 200 includes: a time domain broader 210 and a spectrum shaper 220. The time domain broader 210 is configured to broaden the seed pulses δ1 to a hundred-picosecond level or even a nanosecond level, and fine-tune a pulse width of the seed pulses. The spectrum shaper 220 is configured to perform spectrum shaping on the seed pulses δ1 to obtain saddle chirped pulses δ2 with a spectrum intensity descending from both sides to a center.

As illustrated in FIG. 2, the time domain broader 210 in embodiments of the present disclosure is an offner broader based on a diffraction grating, including a thin film polarizer 211, a Faraday rotator 212, a half-wave plate 213, a diffraction grating 214, a concave mirror 215, and a convex mirror 216 that are placed in the order of the light path. A ridge retroreflector 217 and a plane reflector 218 are provided between the half-wave plate 213 and the diffraction grating 214, and the ridge retroreflector 217 is disposed close to the half-wave plate 213. The concave mirror 215 and the convex mirror 216 are arranged alternatively one above the other, and the ridge retroreflector 217 and the plane reflector 218 are arranged alternatively one above the other. A radius of curvature of the convex mirror is half of that of the concave mirror 215. The convex mirror 216 is located at a focus location of the concave mirror 215.

The spectrum shaper 220 is a mechanical spectrum shaper, and located between the concave mirror 215 and the convex mirror 216. The mechanical spectrum shaper includes one or more opaque mechanical sheets, and a slit exists between two adjacent opaque mechanical sheets. The mechanical spectrum shaper mechanically shades a long diffracted beam to shape the laser spectrum output by the broader. In the offner time domain broader, the broadband seed pulses are diffracted by a grating and collimated by a lens, so as to form a collimated long diffraction spot whose spectral components are linearly related to its relative location. The spectral distribution and the shape of the broadened pulses may be shaped by using one or more thin opaque materials with different thicknesses to shade part of or all the long diffracted light spot. Optical diffraction is advantageous for achieving the saddle spectrum during narrow thin spectral shaping.

The Faraday rotator 212 is configured to rotate a polarization angle of incident polarized light by 45°, and separate and isolate incident light and emergent light in combination with the half-wave plate 213 and the thin film polarizer 211, which may be used as an optical isolator.

The diffraction grating 214 transmits light with a size of 65×25 mm2. A ruling cycle of the diffraction grating is 1740 lines/mm, and a single-pass diffraction efficiency of laser at a waveband of 1030 nm is greater than 95%. The diffraction grating 214 is placed at a distance s of 500 mm from the concave mirror (R1<s<R2).

The distance s is a distance between the diffraction grating and the concave mirror, and R represents a curvature of the concave mirror or the convex mirror. The curvature of the convex mirror is set as R1 and the curvature of the concave mirror is set as R2. In detail, the convex mirror 216 in embodiments of the present disclosure has a curvature R1 of 400 mm, which is half of the curvature R2 (800 mm) of the concave mirror 215. The convex mirror is located at a focus location (R/2) of the concave mirror. The grating 214 is placed at a distance s of 500 mm from the concave mirror (R1<s<R2). The concave mirror and the convex mirror form a telescopic system.

In embodiments of the present disclosure, the spectrum shaping broader 200 performs time domain broadening and spectral shaping on the broadened seed pulses to obtain signal light δ2′ and signal light δ2 in turn. The pulse width is broadened to 400 ps, carrying a positive linear chirp, and the pulse shape is close to parabolic. The energy is reduced by about half compared to δ1, and other parameters remain unchanged. The signal light δ2 has a further loss of energy compared to the signal light δ2′, and the spectral shape is modulated by the spectrum shaper to a saddle shape as shown in FIG. 5.

The broadening of the time domain broader 210 is as follows. The incident seed pulses δ1 enter into the diffraction grating 214 after passing through the thin film polarizer 211, the Faraday rotator 212, and the half-wave plate 213. The incident light is diffracted by the diffraction grating 214 to form lasers with different wavelengths, and the lasers with different wavelengths reach the concave mirror 215. The incident laser in a short-wave direction reaches an upper side of the concave mirror 215, and the incident laser in a long-wave direction reaches a lower side of the concave mirror 215. The incident laser in the short-wave direction and the incident laser in a long-wave direction are reflected by the concave mirror 215 and arrive at the convex mirror 216 respectively, and reflected by the convex mirror 216 to reach the diffraction grating 214. In this process, when the long and short waves pass through the spectrum shaper 220, spectral shaping is performed on the incident light. After the diffraction by the diffraction grating 214, the laser pulse frequency in space is distributed linearly (i.e., spatial chirp), so that the light spot is a horizontal long strip, and the light spot is reflected by the ridge retroreflector 217 to back to the diffraction grating 214. After the light spot is reflected by the concave mirror 215, the spectrum shaper 220, the convex mirror 216, the diffraction grating 214 to the plane reflector 218, the emergent light spot may restore to a shape of the incident light spot, so as to eliminate the spatial chirp, which is a broadening and shaping process.

After the first broadening process is completed, the pulses are reflected by the plane reflector 218 to the diffraction grating 214, and then reach the plane reflector 218 again after passing through the concave mirror 215, the spectrum shaper 220, the convex mirror 216, the diffraction grating 214, the ridge retroreflector 217, the diffraction grating 214, the concave mirror 215, the spectrum shaper 220, the convex mirror 216, and the diffraction grating 214 in turn, which realizes the second broadening and shaping process, so that the seed pulses are broadened to a hundred-picosecond level or a nanosecond level to obtain the saddle chirped pulses δ2 with a spectrum intensity descending from both edges to a center. Finally, the saddle chirped pulses δ2 are emitted after passing through the half-wave plate 213, the Faraday rotator 212, and the thin film polarizer 211.

As illustrated in FIG. 3, the self-similar regenerative amplifier 300 in embodiments of the present includes a pulse input and output coupling component and a pulse regenerative amplification component. The pulse input and output coupling component includes: a first thin film polarizer 301, a first half-wave plate 302 and a first Faraday rotator 303. The pulse input and output coupling component is configured to receive the saddle chirped pulses injected by the spectrum shaping broader and inject the received saddle chirped pulses to the pulse regenerative amplification component. The first Faraday rotator 303, as a magneto-optical crystal device, is set close to the pulse regenerative amplification component, and configured to rotate the incident polarized light by a polarization angle of 45°. The first Faraday rotator 303 together with the first half-wave plate 302 and the first thin film polarizer 301 form an optical isolator, which is capable of performing coupling or isolation on the incident light and the emergent light.

The pulse regenerative amplification component may perform multiple stepwise amplifications back and forth on the saddle chirped pulses. The pulse regenerative amplification component includes: a first plane reflector 307, a Pockels cell 306, a quarter-wave plate 305, a second thin film polarizer 304, a highly nonlinear crystal 309, a gain crystal 312 and a second plane reflector 314 disposed in sequence. The second thin film polarizer 304 is disposed opposite to the first Faraday rotator 303. The second thin film polarizer 304 is configured to receive the saddle chirped pulses from the first Faraday rotator 303, rotate the saddle chirped pulses by a set angle, and lead the saddle chirped pulses rotated into the quarter-wave plate 305.

A third plano-convex lens 311 and a fourth plano-convex lens 313 are provided on both sides of the gain crystal 312, respectively, and a first plano-convex lens 308 and a second plano-convex lens 310 are provided on both sides of the highly nonlinear crystal 309, respectively. The first plano-convex lens 308, the second plano-convex lens 310, the third plano-convex lens 311, the fourth plano-convex lens 313, the first plane reflector 307 and the second plane reflector 314 together form a regenerative chamber. The highly nonlinear crystal 309 is disposed at a focus location of a convex lens group formed by the first plano-convex lens 308 and the second plano-convex lens 310, and the gain crystal 312 is disposed at a focus location of a convex lens group formed by the third plano-convex lens 311 and the fourth plano-convex lens 313.

The Pockels cell 306 is a quarter-wave fast electro-optical device, which behaves as a quarter-wave sheet under high voltage (>2 kV) operation. A rising edge and a falling edge of response time of the Pockels cell to high voltage signal are less than 10 ns. The Pockels cell and the quarter-wave plate together form an optical regulator for adjusting a polarization direction of polarized light by controlling opening and closing of the Pockels cell 306, so that multiple stepwise amplifications and multiple nonlinear spectrum broadening are performed on the saddle chirped pulses back and forth between the first plane reflector and the second plane reflector.

All optical elements in the self-similar regenerative amplifier 300 operate at a waveband of 1030 nm and are coated with an anti-reflective film or a highly reflective film. An overall cavity length of the regenerative cavity is 2.2 m. The gain crystal 312 is preferably a Yb:CaF2 crystal with a size of 3 mm×10 mm×10 mm. The crystal is cut at an Brewster angle, which may enhance a loss threshold of a crystal. The concentration of the ytterbium ion is 3 at %. Under 976 nmLD pumping, the signal light at 1030 nm may be effectively gained, so as to amplify the power of the signal light and enhance the energy of the signal light.

The nonlinear crystal 309 is selected as a thin silicon dioxide sheet with a size 20 mm×20 mm×1.5 mm and a nonlinear refractive index of n2=3.0×10-20 m2/W. The incident laser pulses with a pulse peak power exceeding a MW level activate the self-phase modulation effect, so as to achieve the spectrum broadening. The nonlinear crystal 309 achieves the self-similar regenerative amplification, so as to solve the problem that the self-similar pulse evolution is hard to be achieved in the low nonlinear solid gain medium, and provide a new manner to suppress gain narrowing in the multi-pass regenerative amplification.

The regenerative amplification route after injecting the saddle chirped pulses δ2 into the self-similar regenerative amplifier 300 is as follows. The saddle chirped pulses δ2 pass through the first thin film polarizer 301, the first half-wave plate 302 and the first Faraday rotator 303 in turn, and reach the second thin film polarizer 304. The saddle chirped pulses δ2 are polarized and rotated at a certain angle by the second thin film polarizer 304 and transmitted to the quarter-wave plate 305, and then the saddle chirped pulses δ2 passes through the Pockels cell 306 (which is in a closed state) to reach the first plane reflector 307. After being reflected by the first plane reflector 307, the saddle chirped pulses δ2 pass through the quarter-wave plate 305 and the second thin film polarizer 304, and then are transmitted through the first plano-convex lens 308, the highly nonlinear crystal 309, the second plano-convex lens 310, the third plano-convex lens 311, the gain crystal 312, the fourth plano-convex lens 313 and reaches the second plane reflector 314 in sequence. At this time, after opening the Pockels cell 306, the second plane reflector 314 returns the pulses to the second thin film polarizer 304 in the original way, and the pulses transmit through the second thin film polarizer 304 and pass through the quarter-wave plate 305 and the Pockels cell 306 to reach the first plane reflector 307. Multiple stepwise amplifications and multiple nonlinear spectrum broadening are performed on the pulses back and forth between the first plane reflector 307 and the second plane reflector 314 until a pulse peak power exceeds a MW level. After the signal light pass through the gain medium as a focused light spot and then pass through the highly nonlinear medium as the focused light spot, the nonlinear spectrum broadening is enhanced. When the chirped pulses after self-similar amplification reach gain saturation, high-energy chirped pulses are output to the pulse input and output coupling component. The pulse input and output coupling component receives the high-energy chirped pulses and outputs the high-energy chirped pulses into the pulse compressor. The pulse compressor compresses the high-energy chirped pulses after the regenerative amplification, and outputs the compressed pulses.

As the number of cyclic amplification turns increases, the pulse energy increases continuously and the pulse peak power also increases. When the pulse peak power reaches the MW level, and the incident laser transmits through a Kerr medium with high nonlinearity, it induces nonlinear effects such as self-phase modulation and four-wave frequency mixing, resulting in the pulse spectrum broadening. The seed pulses are injected into the self-similar regenerative amplifier 300 after passing through the time domain broader 210 and the spectrum shaper 220, and the broadened pulse spectrum may effectively suppress the gain narrowing in the high-energy regenerative amplification process, which facilitates the subsequent realization of higher quality pulse compression, to obtain femtosecond pulses with less than 100 femtosecond or even few-cycle level.

In the above-mentioned amplification process, in the self-similar regenerative amplification process, when the number of amplification turns is less than 50 (a roundtrip between the first plane reflector 307 and the second plane reflector 314 is taken for a turn), the pulses obtain the energy boost after passing through the gain crystal, the gain effect gradually modulated the saddle spectrum into a flat spectrum, which effectively suppresses the gain narrowing. However, the peak power is still less than the MW level, and the nonlinear spectral broadening is not obvious when the pluses pass through the highly nonlinear medium. If the number of amplification turns larger than 50, the pulse peak power reaches the MW level, and the pluses pass through the gain medium as a relatively large light spot to avoid the nonlinear time-frequency distortion, and then pass through the high nonlinear medium as a converged beam to obtain the nonlinear spectrum broadening and realize the self-similar pulse evolution.

The broadened pulse spectrum may effectively suppress the gain narrowing during the high-energy regenerative amplification process, and facilitate the subsequent realization of the higher-quality pulse compression to obtain femtosecond pulses with less than 100 femtosecond or even few-cycle level. In FIG. 6, the changes in pulse energy and spectral width of different shapes of incident pulses in the self-similar regenerative amplifier with the change of the number of amplification turns. Firstly, if other initial parameters are the same, for two different shapes of the incident pulses, the pulse energy may be increased to nearly 4 mJ after 70 turns of regenerative amplification with the amplification efficiency larger than 60 dB. During the amplification process, the pulse energy increases exponentially with the number of amplification turns, and the energy saturation tends to appear near the 70th turn. In comparison, the saddle pulse finally obtains a slightly higher energy and has more amplification advantages.

Secondly, for the gain narrowing suppression and the self-similar spectrum broadening during the amplification process, the saddle incident spectrum in embodiments of the present disclosure has obvious advantages as shown in FIG. 6 (b). In the case of a uniform incident spectrum width (7 nm), the gain narrowing effect is significant for the first 57 turns of the amplification process when the incident spectrum is Gaussian, and the spectral width is narrowed nearly 1 nm (narrowed by about 14%). As the energy of the amplified pulse increases, the spectral broadening caused by nonlinear effects is realized. After 70 turns of amplification, the width of the Gaussian spectrum is back to 6.5 nm. In comparison, the gain narrowing effect is significantly suppressed in the first 50 turns for the saddle incident spectrum, and the spectral width is narrowed from 7 nm to about 6.8 nm (narrowed by about 3%). Moreover, the nonlinear spectrum broadening of the saddle incident spectrum is more significant with energy enhancement, and the spectrum is broadened to nearly 7.8 nm after 70 turns of pulse amplification (spectrum is broadened by about 11%). FIG. 7 shows the detailed pulse evolution process of Gaussian incident pulses (a) and (c) and saddle incident pulses (b) and (d) in the self-similar regenerative amplifier. The outermost part of the 1st to 80th pulse curves in figure (c) of FIG. 7 is the 1st pulse curve, and the pulse curves are 1st, 40th, 60th, 65th and 67th pulse curves from the outside to the inside, and the innermost part of the 1st to 80th pulse curves in figure (d) of FIG. 7 is the 1st pulse curve, and the pulse curves are 1st, 40th, 60th, 65th and 67th pulse curves from the inside to the outside.

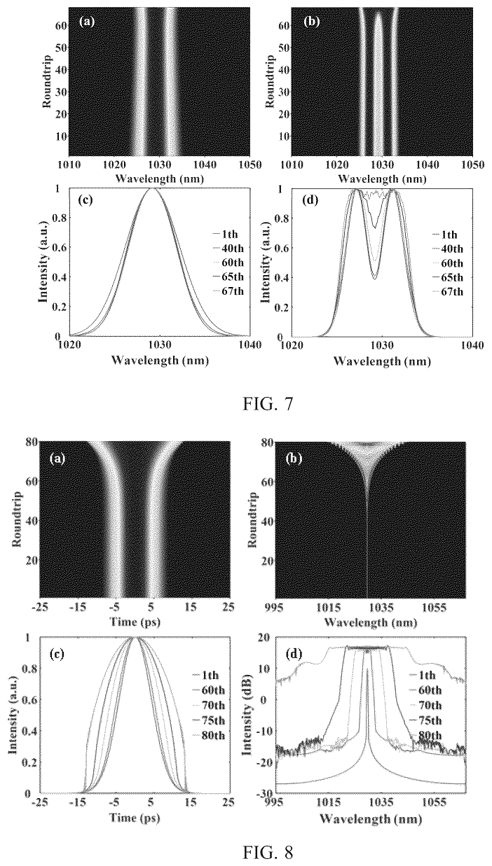

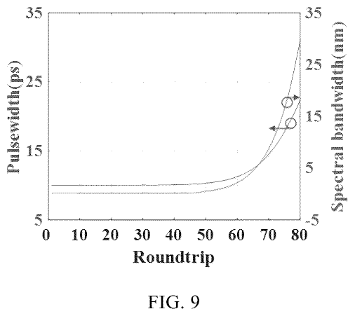

FIG. 8 and FIG. 9 show the pulse evolution process of narrow band incident pulses in the self-similar regenerative amplifier, in which the 1st pulse curve is at the innermost side in the 1st to 80th pulse curves in figure (c) of FIG. 8, and the number of turns increases sequentially from inner to outer. The 1st pulse curve is at the innermost side in the 1st to 80th pulse curves in figure (d) of FIG. 8, and the number of turns increases sequentially from inner to outer. The width of the incident signal light is 10 ps, the spectral width is less than 0.5 nm, the pulse energy is 1 nJ, and the central wavelength is 1030 nm. As shown in FIG. 8, during the pulse regeneration amplification process, the pulse energy increases as the number of amplification turns increases. When the number of amplification turns exceeds 60, the high peak power pulses induce the pulses in the self-similar regenerative amplifier to achieve the self-similar amplification evolution, the pulse width and spectral width are broadened faster with increase of the number of amplification turns and the energy boost. The pulses gradually evolve from a Gaussian shape to a parabolic shape in figured (c) of FIG. 8, which is consistent with the evolution principles of self-similar pulses. After 80 turns of magnification, the pulse width is broadened to 18 ps (to 1.8 times) and the spectral width is broadened to nearly 30 nm (in FIG. 9).

### Example 2

The self-similar regenerative amplification method for femtosecond laser chirped pulses in embodiments is the same as Example 1, the difference lies only in the structure of the spectrum shaping broader 200 and the number of broadenings. The self-similar regenerative amplification apparatus for femtosecond laser chirped pulses in the embodiment includes: the broadband seed source 100, the spectrum shaping broader 200, the self-similar regenerative amplifier 300 and the pulse compressor 400 disposed in order of a light path from one side to the other side. In detail, the broadband seed source 100, the self-similar regenerative amplifier 300 and the pulse compressor 400 in Example 2 are the same as that in Example 1, and the difference lies only in the structure of the spectrum shaping broader 200.

In detail, the time domain broader 210 in the spectrum shaping broader 200 provided in the example is an optical fiber broader implemented based on a chirped Bragg grating, and the spectrum shaper 220 is an optical interference filter shaper implemented based on a birefringence effect.

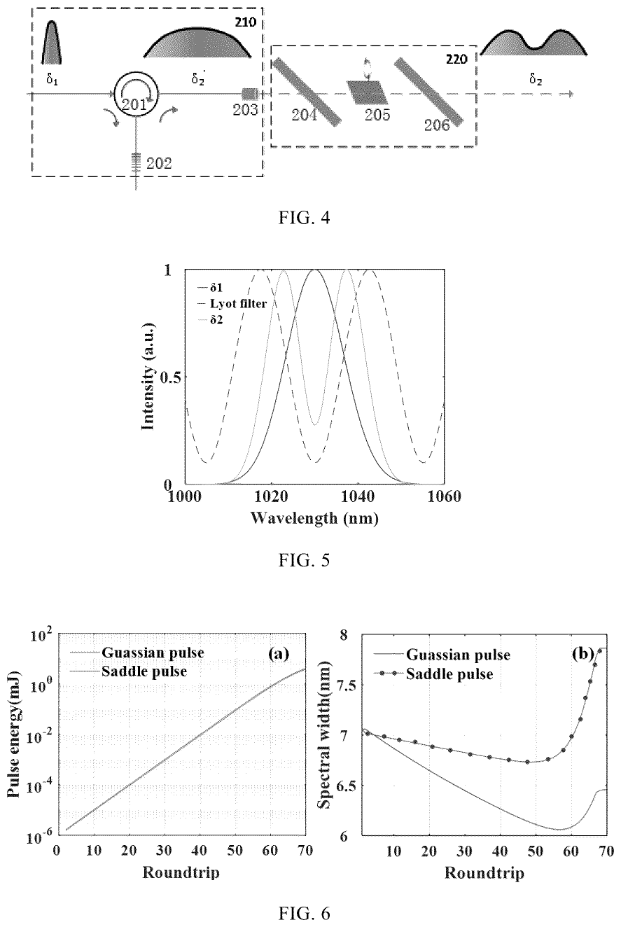

As illustrated in FIG. 4, the time domain broader 210 in the example includes: a fiber annulus 201, a chirped fiber Bragg grating 202 and a fiber collimator 203 disposed in order of the optical path. A first port, a second port and a third port are arranged on the fiber annulus 201 at intervals, an incident signal light from the first port is unidirectionally transmitted to the second port, and an incident signal light from the second port is unidirectionally transmitted to the third port. The chirped fiber Bragg grating has a reflection bandwidth of 20 nm, a reflection rate greater than 50%, a dispersion coefficient of 50 ps/nm, and an optical fiber type of PM980. The fiber collimator 203 typically has a working distance of 1 m and may collimate the incident laser to output in a free space.

The spectrum shaper 220 includes a third film polarizer 204, a birefringence medium 205 and a fourth film polarizer 206 disposed in order of the optical path. The birefringence medium 205 is quartz crystal, a birefringence coefficient B=0.0092, an angle between an incident laser polarization direction and a main axis of the birefringence medium is 15°. An angle formed between an optical axis of the birefringence medium 205 and a laser transmission polarization axis is 0, in which 0°<θ<90°. The transfer function of the Lyot filter formed by the birefringent medium 205 is shown by the dashed lines in FIG. 5.

As shown in FIG. 5, the seed pluses have a central wavelength of 1030 nm and a spectral half-height full width of 15 nm. After the spectrum shaping, the output spectrum has a saddle shape with a spectrum intensity descending from both edges to a center.

Finally, it should be noted that the above embodiments are used only to illustrate the technical solution of the disclosure and not to limit it, and those skilled in the art should know that those modifications or equivalent substitutions to the technical solution of the present disclosure, without departing from the purpose and scope of the technical solution, should be covered by the scope of the claims of the disclosure.

What is claimed is:

1. A self-similar regenerative amplification method for femtosecond laser chirped pulses, comprising:
continuously injecting seed pulses into a spectrum shaping broader, performing a time domain broadening process on the injected seed pulses by a time domain broader, and performing spectrum shaping on the broadened pulses by a spectrum shaper during or after the time domain broadening process, to obtain saddle chirped pulses:
injecting the saddle chirped pulses into a regenerative amplification chamber of a self-similar regenerative amplifier, and obtaining gains in spectrums of the saddle chirped pulses after multiple stepwise amplifications back and forth in the regenerative amplification chamber by a gain crystal and a nonlinear crystal to transfer spectrum intensities of the saddle chirped pulses evolve from a saddle shape to a flat shape: performing multiple stepwise amplifications back and forth on flat chirped pulses in the regenerative amplification chamber using the gain crystal, so that when a pulse peak power exceeds a MW level, nonlinear spectrum broadening is accomplished on the flat chirped pulses by the nonlinear crystal; in the process of regenerative amplification, after the chirped pulses pass through a gain medium as a focused light spot and then pass through a nonlinear medium as the focused light spot after being collimated by a lens, enhancing the nonlinear spectrum broadening to enable the chirped pulses after self-similar amplification to reach gain saturation, and outputting high-energy chirped pulses; and
injecting the high-energy chirped pulses after gain saturation into a pulse compressor, and outputting compressed pulses after pulse compression of the high-energy chirped pulses by the pulse compressor.

2. The method of claim 1, wherein performing the time domain broadening on the seed pulses and performing spectrum shaping on the broadened pulses comprise:
performing multiple time domain broadening on the seed pulses by the time domain broader, and performing the spectrum shaping on the broadened pulses during the time domain broadening by the spectrum shaper; or
performing the time domain broadening once on the seed pulses by the time domain broader, and performing the spectrum shaping on the broadened pulses by the spectrum shaper after the time domain broadening process.

3. The method of claim 1, wherein the gain crystal in the self-similar regenerative amplifier is a laser crystal doped with rare earth ions, and the laser crystal emits spontaneous radiation laser after being activated by pump light.

4. The method of claim 3, wherein the rare earth ions doped in the laser crystal are neodymium ions or ytterbium ions, and the spontaneous radiation laser is Yb:CaF2 spontaneous radiation laser, Yb:CALGO spontaneous radiation laser, Yb:CALYO spontaneous radiation laser, or Yb:KGW/KYW spontaneous radiation laser.

5. The method of claim 1, wherein the nonlinear crystal is a crystal material having a high third-order nonlinear optical polarization rate.

6. The method of claim 5, wherein the nonlinear crystal is selected from silicon dioxide, calcium fluoride, or aluminum oxide.

7. A self-similar regenerative amplification apparatus for femtosecond laser chirped pulses, comprising:
a broadband seed source configured to emit seed pulses:
a spectrum shaping broader configured to receive the seed pulses from the broadband seed source and output saddle chirped pulses:
a self-similar regenerative amplifier comprising:
a pulse input and output coupling component configured to receive the saddle chirped pulses injected by the spectrum shaping broader and output the received saddle chirped pulses; and
a pulse regenerative amplification component configured to receive the saddle chirped pulses output from the pulse input and output coupling component and perform multiple stepwise amplifications back and forth on the saddle chirped pulses to obtain high-energy chirped pulses; and
a pulse compressor configured to compress the high-energy chirped pulses and output compressed pulses,
wherein the broadband seed source, the spectrum shaping broader, the self-similar regenerative amplifier and the pulse compressor are disposed in order of a light path from one side to the other side.

8. The apparatus of claim 7, wherein the spectrum shaping broader comprises:
a time domain broader configured to broaden the seed pulses to a hundred-picosecond level or even a nanosecond level, and fine-tune a pulse width of the seed pulses; and
a spectrum shaper configured to perform spectrum shaping on the broadened pulses to obtain the saddle chirped pulses.

9. The apparatus of claim 7, wherein the pulse regenerative amplification component comprises:
a gain crystal; and
a nonlinear crystal located on a side where the gain crystal is located and in the same optical path as the gain crystal, and configured to perform multiple stepwise amplifications and multiple nonlinear spectrum broadenings back and forth on the saddle chirped pulses together with the gain crystal until a pulse peak power exceeds a MW level; wherein after the chirped pulses pass through the gain crystal as a focused light spot and then pass through the nonlinear crystal as the focused light spot after being collimated by a lens, the nonlinear spectrum broadening is enhanced until the chirped pulses reach gain saturation after self-similar amplification, and the pulse regenerative amplification component is further configured to output high-energy chirped pulses to the pulse input and output coupling component; the pulse input and output coupling component is further configured to receive and output the high-energy chirped pulses.

10. The apparatus of claim 8, wherein the time domain broader is an offner grating time domain broader, and comprises a thin film polarizer, a Faraday rotator, a half-wave plate, a diffraction grating, a concave mirror, and a convex mirror that are placed in order of the light path,
wherein a ridge retroreflector and a plane reflector are provided between the half-wave plate and the diffraction grating, and the ridge retroreflector is disposed close to the half-wave plate;
the concave mirror and the convex mirror are arranged alternatively one above the other, and the ridge retroreflector and the plane reflector are arranged alternatively one above the other;
a radius of curvature of the convex mirror is half of that of the concave mirror;
the convex mirror is located at a focus location of the concave mirror; and
the spectrum shaper is a mechanical spectrum shaper, and located between the concave mirror and the convex mirror, the mechanical spectrum shaper comprises one or more opaque mechanical sheets, and a slit exists between two adjacent opaque mechanical sheets.

11. The apparatus of claim 10, wherein the Faraday rotator is configured to rotate a polarization angle of incident polarized light by 45°, and separate and isolate incident light and emergent light in combination with the half-wave plate and the thin film polarizer, and is used as an optical isolator.

12. The apparatus of claim 10, wherein a working waveband of any of the thin film polarizer, the Faraday rotator, the half-wave plate, the diffraction grating, the concave mirror, the convex mirror, the ridge retroreflector and the plane reflector is 1030 nm:
a ruling cycle of the diffraction grating is 1740 lines/mm, and a single-pass diffraction efficiency of laser at a waveband of 1030 nm is greater than 95%.

13. The apparatus of claim 8, wherein the time domain broader is an optical fiber broader implemented based on a chirped Bragg grating, and the spectrum shaper is an optical interference filter shaper implemented based on a birefringence effect;
the time domain broader comprises a fiber annulus, a chirped fiber Bragg grating and a fiber collimator disposed in order of an optical path, a first port, a second port and a third port are arranged on the fiber annulus at intervals, an incident signal light from the first port is unidirectionally transmitted to the second port, and an incident signal light from the second port is unidirectionally transmitted to the third port: the chirped fiber Bragg grating has a reflection bandwidth of 20 nm, a reflection rate greater than 50%, a dispersion coefficient of 50 ps/nm, and an optical fiber type of PM980; and
the spectrum shaper comprises a third film polarizer, a birefringence medium and a fourth film polarizer disposed in order of the optical path, the birefringence medium is quartz crystal, a birefringence coefficient B=0.0092, an angle between an incident laser polarization direction and a main axis of the birefringence medium is 15°; and an angle formed between an optical axis of the birefringence medium and a laser transmission polarization axis is 0, wherein 0°<θ<90°.

14. The apparatus of claim 9, wherein the pulse input and output coupling component comprises a first thin film polarizer, a first half-wave plate, a first Faraday rotator disposed in sequence: the first Faraday rotator is disposed close to the pulse regenerative amplification component, the first Faraday rotator is a magneto-optical crystal device, a polarization angle of polarized light rotates by 45° after the polarized light passes through the first Faraday rotator; the first Faraday rotator, the first half-wave plate and the first thin film polarizer constitute an optical isolator, and the optical isolator is configured to perform coupling or isolation on incident light and emergent light;
the pulse regenerative amplification component further comprises a first plane reflector, a Pockels cell, a quarter-wave plate, a second thin film polarizer and a second plane reflector disposed in sequence; the gain crystal and the nonlinear crystal are located between the second plane reflector and the second thin film polarizer; the second thin film polarizer is disposed opposite to the first Faraday rotator, and the second thin film polarizer is configured to receive the saddle chirped pulses from the first Faraday rotator, rotate the saddle chirped pulses by a set angle and direct the saddle chirped pulses into the quarter-wave plate.

15. The apparatus of claim 14, wherein a first plano-convex lens and a second plano-convex lens are provided on both sides of the nonlinear crystal, respectively, and a third plano-convex lens and a fourth plano-convex lens are provided on both sides of the gain crystal, respectively; the first plano-convex lens, the second plano-convex lens, the third plano-convex lens, the fourth plano-convex lens, the first plane reflector and the second plane reflector together form a stable regenerative chamber; the nonlinear crystal is placed at a focus location of a convex lens group formed by the first plano-convex lens and the second plano-convex lens, and the gain crystal is placed at a focus location of a convex lens group formed by the third plano-convex lens and the fourth plano-convex lens;
the Pockels cell is a quarter-wave fast electro-optical device, and the Pockels cell and the quarter-wave plate together form an optical regulator for adjusting a polarization direction of polarized light by controlling opening and closing of the Pockels cell, so that multiple stepwise amplifications and multiple nonlinear spectrum broadenings are performed on the saddle chirped pulses back and forth between the first plane reflector and the second plane reflector.
